(19) United States
(12) Patent Application Publication
(10) Pub. No.: US 2007/0057039 A1
(43) Pub. Date: Mar. 15, 2007

(54) Charge card network with an implementation to enable card owners to limit the use of their cards to sales points in designated geographic areas and to sales points for designated types of goods and services

(76) Inventors: Michael P. Carlson, Austin, TX (US); Herman Rodriguez, Austin, TX (US)

Correspondence Address: IBM CORPORATION;INTELLECTUAL PROPERTY LAW, 11400 BURNET ROAD, AUSTIN, TX, 78758, US

(21) Appl. No.: 11/226,745

(22) Filed: Sep. 14, 2005

(51) Int. Cl. G06K 5/00; G06Q 40/00

(52) U.S. Cl. 235/380; 705/39; 705/44

(57) ABSTRACT

An implementation enabling an owner of a charge card to limit purchases made with the charge card comprising an implementation enabling the owner of a charge card to limit purchases made with the charge card to purchases of either owner defined types of goods and/or owner defined geographical areas, and prohibiting purchases made with the charge card other than purchases within these limitations as defined by the card owner. The owner will be enabled to limit the purchases to particular goods or to particular sales establishments. Also, the charge card with limitations will generally be a secondary charge card issued to either a member in the family of the owner or an employee of the owner.

### TECHNICAL FIELD

The present invention relates to the credit card industry in which, for over a generation, the users and owners of credit cards are able to complete purchases and draw cash at hundreds of thousands of networked sale point terminals and ATM (automatic teller machine) terminals throughout the world.

### BACKGROUND OF RELATED ART

Computers and their application programs are used in all aspects of business, industry and academic endeavors. The computer industry has been a force for bringing about great increases in business and industrial productivity. Almost every week seems to bring computer industry advances that promise even further increases in productivity. These advances offer to drive down business and industry costs and increase efficiency, as well as increasing productivity. In addition, the cost of “computer power” continues to drop as a result of rapid advances in computer related technologies.

Despite all of these advances in computer power availability and cost, there still remains a reluctance in the credit card industry towards rapid technological advance. While the numbers of credit card owners and users have been accelerating over the years, technological innovation towards an ultimate primarily electronic consumer non-cash and non-check purchasing and payment system has been conservative. This, of course, has been limited by industry concerns about abuse and fraud on the part of some card holders.

One area of potential industry concern is on the ability of the credit owners, i.e. those responsible for control and payment, to limit credit card abuse. The present invention provides an implementation that enables the owner of the credit card to limit its use and, consequently, possible abuses.

### SUMMARY OF THE PRESENT INVENTION

The present invention provides an implementation for reducing the possibilities for credit card abuse. In this electronics age where a great many purchases and like transactions are diverse and decentralized, it is necessary for the owner of the credit cards to empower employees or other family members to use the credit card, i.e. the other's version of the owned credit card. However, there are often circumstances necessitating limitations on credit cards. It is known for the owner of the credit card to put a monetary limitation or cap on credit cards issued to employees or children of the card owner.

Beyond that, the present invention has recognized that there are additional limitations that may be put on credit cards. In the case of a family credit card, it has become customary for the college student to receive a card with a spending level cap. However, now, even high school and elementary school may be given supplemental credit cards for their school and miscellaneous expenses. Of course, with children the parents will be interested in preventing purchases of substance abuse products and pornography, particularly in light of the ease with which credit card purchases may be made over the World Wide Web (Web).

Accordingly, the present invention provides an implementation enabling an owner of a charge card to limit purchases made with said charge card comprising means enabling the owner of a charge card to limit purchases made with the charge card to purchases of either owner defined types of goods and/or owner defined geographical areas, and prohibiting purchases made with the charge card other than purchases within these limitations as defined by the card owner. The owner will be enabled to limit the purchases to particular goods or to particular sales establishments. Also, the charge card with limitation will generally be a secondary charge card issued to either a member in the family of the owner or an employee of the owner.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a generalized view of a portion of a credit card banking network, such as the Web, including credit card terminals that may be used in the practice of the present invention;

FIG. 2 is a block diagram of a data processing system including a central processing unit and network connections via a communications adapter that is capable of implementing the network server, as well as implementing any client display computer terminal;

FIG. 3 is a diagrammatic view of a terminal display screen illustrating how the credit card owner may be prompted through interactive dialog to provide the geographic limitations on a secondary credit card;

FIG. 4 is a display screen like that of FIG. 3 but illustrating how the credit card owner may be prompted through interactive dialog to provide the limitations on a secondary credit card as to the type of goods establishments on which the credit card may be used;

FIG. 5 is an illustrative flowchart describing the setting up of the functions to limit the geographic and establishment/goods type usage of the secondary credit card; and

FIG. 6 is a flowchart of an illustrative run of a program set up according to FIG. 5.

### DETAILED DESCRIPTION OF THE PREFERRED EMBODIMENT

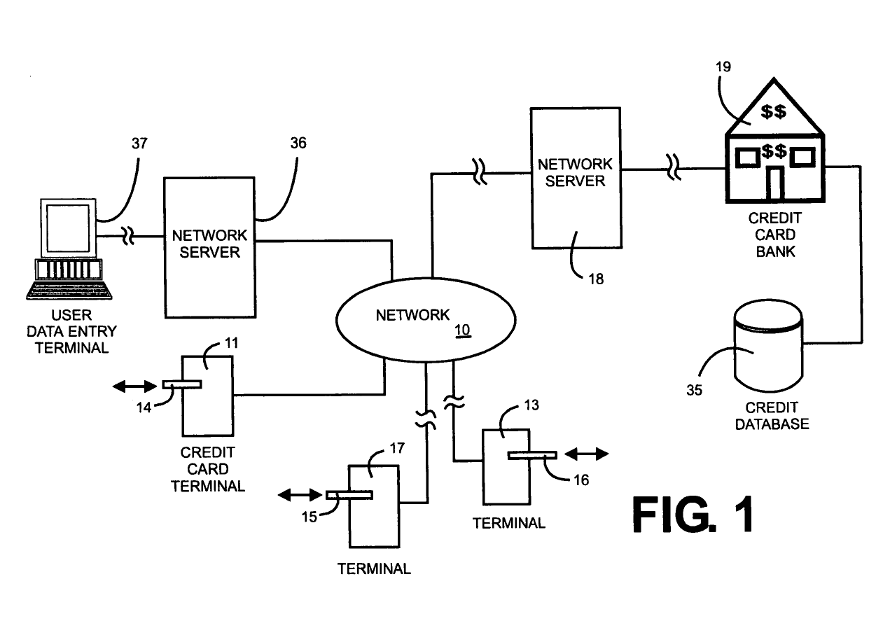

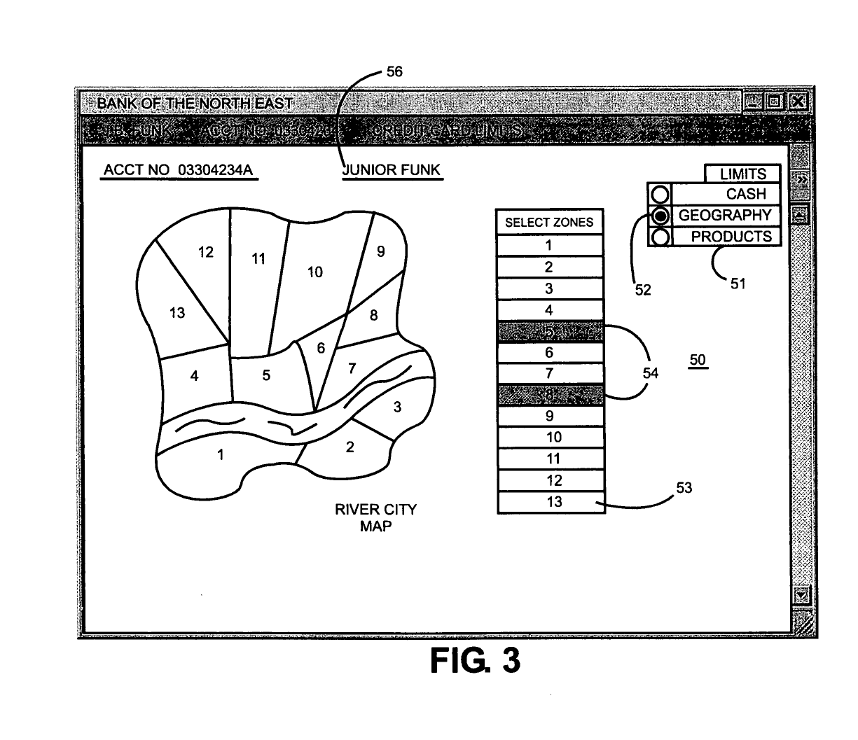

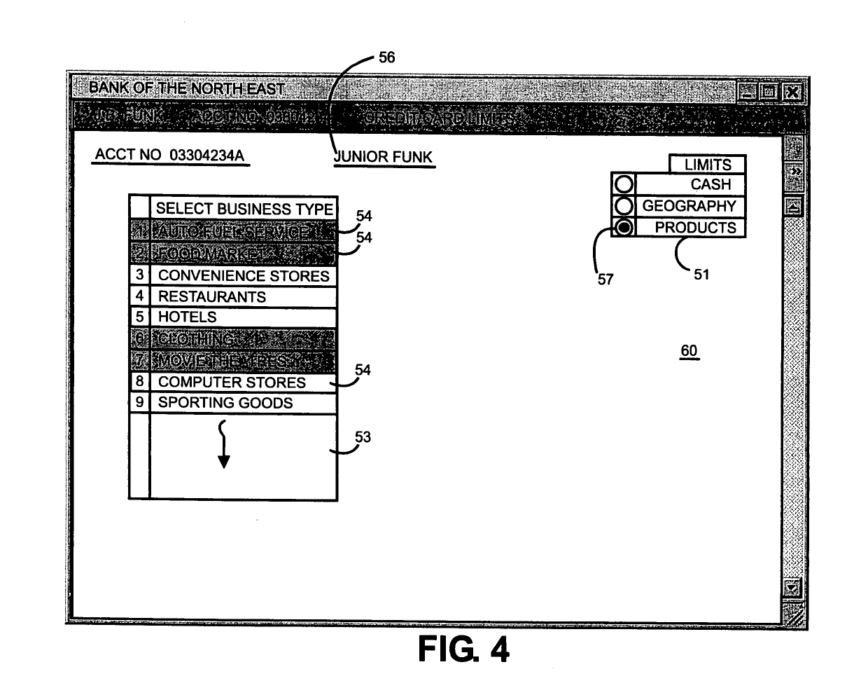

Referring to FIG. 1, there is provided a general illustrative embodiment of a banking transaction network for processing credit card transactions. The operations of such standard networks are well known and the specific operations of such networks need not be described in detail to support the present invention. Credit card terminals 11, 13 and 17 on the network respectively receive credit cards 14, 16 and 15. Of course, the cards need not be inserted in receiving slots; the numbers of the cards may be entered by keying, e.g. Web credit card transactions. The transactions are transmitted over the network 10 usually via appropriate network servers (not shown). The transactions are submitted to the credit card owners bank 19 via network server 18. All information related to the transactions are stored in the bank's database 35 that also stores all appropriate information related to the credit card owner. When the owner of the credit card wishes a secondary credit card for a family member or employee with limitations, the owner accesses the network through any convenient data entry terminal 37 connected to network 10 via an appropriate server 36. The data limiting the usage of the secondary credit card is solicited, as will be described hereinafter with respect to FIGS. 3 and 4. The solicited data limiting the credit card usage is then transmitted via the network to bank 19 where it is available through credit database 35.

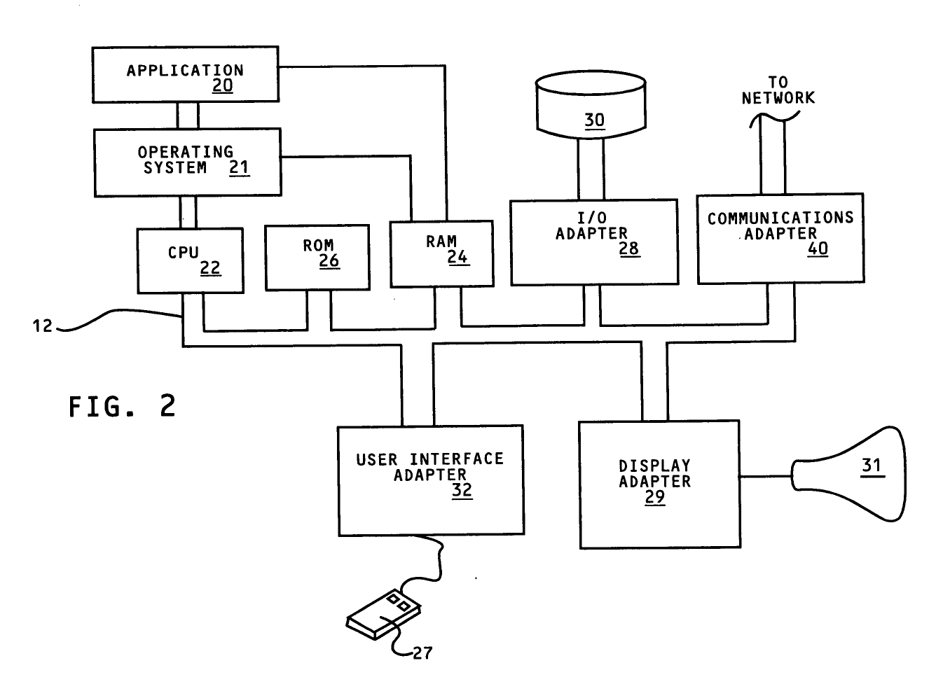

Referring now to FIG. 2, a typical data processing terminal is shown that may function as the user data entry network terminal 37, servers 36 and 18. A Central Processing Unit (CPU) 22, such as one of the PC microprocessors or workstations, e.g. RISC System/6000™ (RS/6000) series available from International Business Machines Corporation (IBM), is provided and interconnected to various other components by system bus 12. An operating system 21 runs on CPU 22, provides control and is used to coordinate the function of the various components of FIG. 2. Operating system 21 may be one of the commercially available operating systems such as the AIX 6000™ operating system available from IBM; Microsoft's Windows98™ or WindowsNT™, as well as UNIX and other IBM AIX operating systems. Application programs 20, controlled by the system, are moved into and out of the main memory, Random Access Memory (RAM) 24. These programs include the programs and routines of the present invention for prompting the credit card owner through interactive dialog to provide the limitations on a secondary credit card as to the type of goods establishments in which the credit card may be used and for limiting the geographical area in which the credit card may be used. Read Only Memory (ROM) 26 is connected to CPU 22 via bus 25 and includes the Basic Input/Output System (BIOS) that controls the basic computer functions. RAM 24, I/O adapter 28 and communications adapter 40 are also interconnected to system bus 25. I/O adapter 28 communicates with the disk storage device 30. Communications adapter 40 interconnects bus 25 with the appropriate outside network enabling the data processing system to communicate, as respectively described above, through the Web or Internet. I/O devices are also connected to system bus 25 via user interface adapter 32 and display adapter 29. Mouse 27 is interconnected to bus 25 through user interface adapter 32. Display adapter 36 supports monitor 38. The display adapter and monitor may be eliminated in the network servers without any display I/O functions.

With reference to FIG. 3, a data entry display terminal is shown, such as display terminal 37, FIG. 1, on which data may be entered through an interactive dialog that may be used to geographically limit use of a secondary credit card. The user has called upon the appropriate program and has identified and verified the credit card owner and the secondary card user 56. The owner is prompted with an appropriate map 55 showing the geographical zones 1 through 13 for “River City” and has been prompted via menu 51 to select the type of limits that the owner wishes to add to the secondary card. The owner has already interactively selected two zones 54 from menu 53. As a result, the use of the secondary credit has been limited to stores and like establishments within zones “5 and 8”.

The FIG. 4 display on which data may be entered through an interactive dialog that may be used to limit the use of a secondary credit card selected types of goods or establishments selling such goods. The user has called upon the appropriate program and has identified and verified the credit card owner and the secondary card user 56. The owner has been first prompted via menu 51 to select the type of limits that the owner wishes to add to the secondary card. Here the owner has selected category 57, types of products. As a result, the user has been prompted via menu 53 to select the type of establishment and has selected: auto fuel and service; food markets; clothing; and movie theaters. As a result, the secondary credit card users are limited to clothing, movies, food and auto fuel and service. Secondary users are, thus, limited to the items from the four categories selected from stores in such categories.

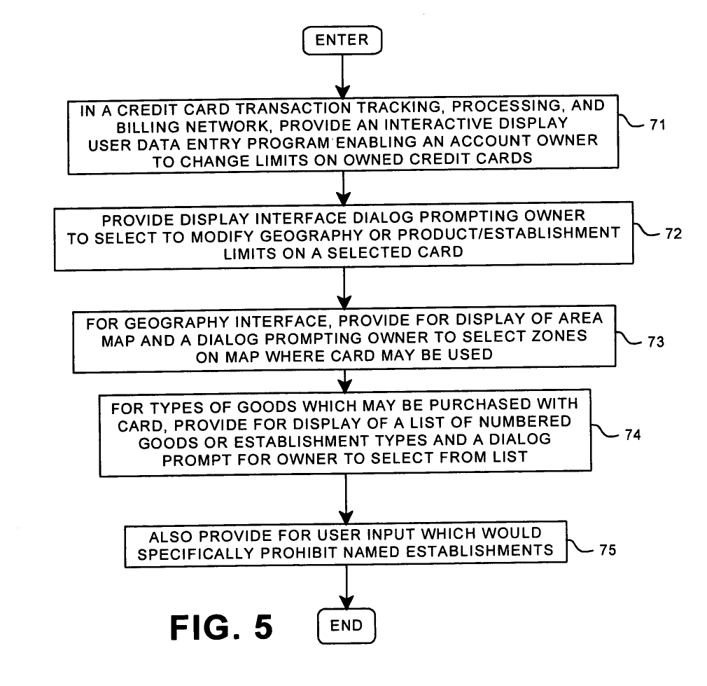

Now, with reference to the programming shown in FIG. 5, the program of the present invention is set up. In a credit card transaction network including tracking, processing and billing, there is provided an interactive display user data entry program for enabling an account owner to change limits on owned credit cards, step 71. This includes the provision of display interface dialogues for prompting the card owner to select to establish or change geographic and/or product/establishment limits on the credit card, step 72. In order to create the interface for selecting geography, there is provided on the interactive display, a map broken into geographic sub-areas together with a series of prompts to enable the user to select the geographic area in which the credit card is to be valid, step 73. Then, in order to create the interface for selecting types of goods limitations, there is provided on the interactive display, a list of numbered goods together with a series of prompts to enable the user to select the numbered goods and/or establishments selling such goods in which the credit card is to be valid, step 74, together with a series of prompts to enable the user to select the goods and or establishments in which the credit card is to be valid. Also, step 75, the owner is enabled to provide input to specially prohibit the use of the credit card in named establishments.

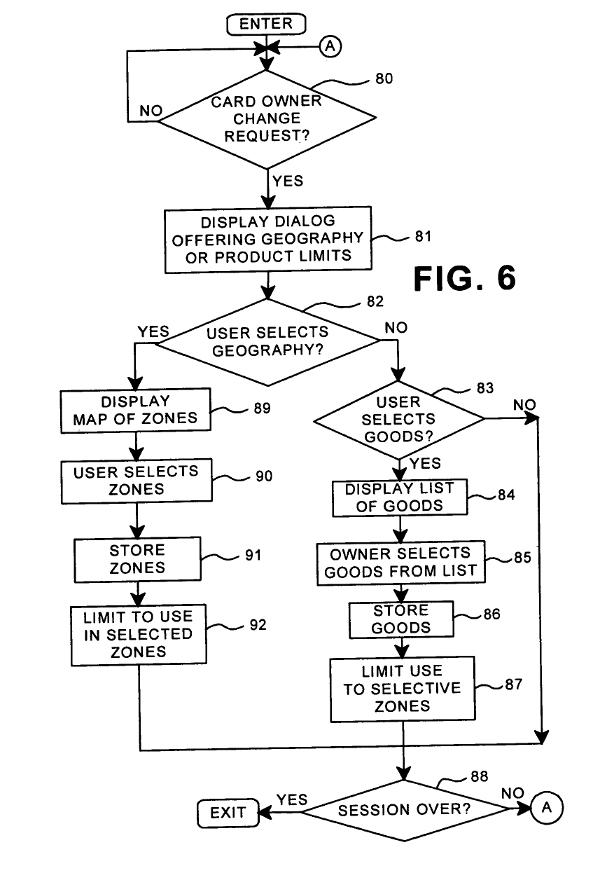

Now, with reference to the flowchart of FIG. 6, a simplified illustrative run of the process set up in FIG. 5 will be described. First, a determination is made as to whether the card owner has requested a change in the limitations in a credit card, step 80. If Yes, a dialog window is displayed that offers to change the product or geography limits of the card, step 81. Then, step 82, a determination is made as to whether the owner has selected to make a change in the geography limitations of the card. If Yes, then, step 89, there is displayed a map of area zones and the user is requested to select the zones in which the card is to be operable. The user then selects the zones, step 90. The zones of operability are stored in association with the controlling bank, step 91. The credit card will then be limited to use in the selected zones, step 92.

On the other hand, if the decision from step 82 had been No, a further decision is made, step 83, as to whether the user has selected limitations relating to goods and services for which the credit card may be used. If Yes, step 84, an appropriate list of types of goods is displayed and the card owner selects from the list the goods and services that may be purchased with the card, step 85. The selected goods and services are stored in association with the controlling bank, step 86. The card will then be limited to be used only for the purchase of the selected goods and services, step 87. Next or after step 92, a decision may conveniently be made as to whether the selection session is over, step 88. If Yes, the session is exited. If No, the session is returned via branch “A” to initial step 80.

It should be noted that the programs covered by the present invention may be stored outside of the present computer systems until they are required. The program instructions may be stored in another readable medium, e.g. in a disk drive associated with the desktop computer or in a removable memory such as an optical disk for use in a CD ROM computer input or in a floppy disk for use in a floppy disk drive computer input. Further, the program instructions may be stored in the memory of another computer prior to use in the system of the present invention and transmitted over a Local Area Network (LAN) or a Wide Area Network (WAN), such as the Internet, when required by the user of the present invention. One skilled in the art should appreciate that the processes controlling the present invention are capable of being distributed in computer readable media of a variety of forms.

Although certain preferred embodiments have been shown and described, it will be understood that many changes and modifications may be made therein without departing from the scope and intent of the appended claims.

What is claimed is:

1. In a system for charging purchases made at a plurality of sale points in a network to a charge card, an implementation enabling an owner of a charge card to limit purchases made with said charge card comprising:
means enabling the owner of a charge card to limit purchases made with said charge card to at least one class of purchases selected from the group consisting of purchases of owner defined types of goods and owner defined geographical areas; and
means for prohibiting purchases made with said charge card other than purchases within said owner defined limitations.

2. The system for charging to a charge card of claim 1 wherein said purchases are limited to owner defined types of goods.

3. The system for charging to a charge card of claim 2 wherein said types of goods are defined by the establishments at which said goods are purchased.

4. The system for charging to a charge card of claim 3 further including means for limiting purchases of goods to and from specific business establishments.

5. The system for charging to a charge card of claim 1 wherein:
said owner owns a primary charge card without said owner defined limitations; and
said charge card with said owner defined limitation is a secondary charge card used by another.

6. The system for charging to a charge card of claim 1 wherein said purchases are limited to owner defined geographical areas.

7. In a system for charging purchases made at a plurality of sales points in a network to a charge card, a method enabling an owner of a charge card to limit purchases made with said charge card comprising:
enabling the owner of a charge card to limit purchases made with said charge card to at least one class of purchases selected from the group consisting of purchases of owner defined types of goods and owner defined geographical areas; and
prohibiting purchases made with said charge card other than purchases within said owner defined limitations.

8. The method for charging to a charge card of claim 7 wherein said purchases are limited to owner defined types of goods.

9. The method for charging to a charge card of claim 8 wherein said types of goods are defined by the establishments at which said goods are purchased.

10. The method for charging to a charge card of claim 9 further including the step of limiting purchases of goods to and from specific business establishments.

11. The method for charging to a charge card of claim 7 wherein:
said owner owns a primary charge card without said owner defined limitations; and
said charge card with said owner defined limitation is a secondary charge card used by another.

12. The method for charging to a charge card of claim 7 wherein said purchases are limited to owner defined geographical areas.

13. The method for charging to a charge card of claim 12 wherein said owner defined geographical areas are defined by the steps of:
displaying a map of geographical areas on a display; and
interactively prompting said owner to indicate the geographical areas within which said purchases with said credit card may be made.

14. A computer program having code recorded on a computer readable medium for enabling an owner of a charge card to limit purchases made with said charge card in a system for charging purchases made at a plurality of sales points in a network to a charge card comprising:
means enabling the owner of a charge card to limit purchases made with said charge card to at least one class of purchases selected from the group consisting of purchases of owner defined types of goods and owner defined geographical areas; and
means for prohibiting purchases made with said charge card other than purchases within said owner defined limitations.

15. The computer program of claim 13 wherein said purchases are limited to owner defined types of goods.

16. The computer program of claim 14 wherein said types of goods are defined by the establishments at which said goods are purchased.

17. The computer program of claim 15 further including means for limiting purchases of goods to and from specific business establishments.

18. The computer program of claim 13 wherein:
said owner owns a primary charge card without said owner defined limitations; and
said charge card with said owner defined limitation is a secondary charge card used by another.

19. The computer program of claim 13 wherein said purchases are limited to owner defined geographical areas.

20. The computer program of claim 18 wherein said owner defined geographical areas are defined by the steps of:
means for displaying a map of geographical areas on a display; and
means for interactively prompting said owner to indicate the geographical areas within which said purchases with said credit card may be made.
